(19) United States
(12) Patent Application Publication
(10) Pub. No.: US 2007/0242671 A1
(43) Pub. Date: Oct. 18, 2007

(54) Method and Apparatus for Routing Data Packets Between Different Internet Communications Stack Instances

(76) Inventors: David Alan Christenson, Fergus Falls, MN (US); Thomas Edwin Murphy JR., Hopewell Junction, NY (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/279,667

(22) Filed: Apr. 13, 2006

(51) Int. Cl. H04L 12/56; H04L 12/28; H04L 12/66

(52) U.S. Cl. 370/392; 370/463

(57) ABSTRACT

A computer system contains multiple Internet communications stack instances, which may or may not share a common hardware network adapter. Packets are routed between different Internet communications stack instances internally within the computer system using Internet Protocol (IP) addressing. A packet arriving in one stack and having a destination IP address associated with another stack is forwarded to the other stack using IP forwarding. Preferably, inter-stack routing of packets may use either globally defined Internet IP addresses or local intranet (encapsulated) IP addresses, and may apply to either inbound or outbound packets. An exemplary embodiment is a production stack having a full range of TCP/IP functions, and a service stack having a limited range of TCP/IP functions. The inter-stack interface can be used to obtain advanced function operations for packets arriving for and being sent by applications bound to the service stack.

### FIELD OF THE INVENTION

The present invention relates generally to digital data processing, and more particularly to the use of an Internet communications stack, such as a TCP/IP stack, within a computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users. At the same time, the cost of computing resources has consistently declined, so that information which was too expensive to gather, store and process a few years ago, is now economically feasible to manipulate via computer. The reduced cost of information processing drives increasing productivity in a snowballing effect, because product designs, manufacturing processes, resource scheduling, administrative chores, and many other factors, are made more efficient.

The reduced cost of computing and the general availability of digital devices has brought an explosion in the volume of information stored in such devices. With so much information stored in digital form, it is naturally desirable to obtain wide access to the information from computer systems. The volume of information dwarfs the storage capability of any one device. To improve information access, various techniques for allowing computing devices to communicate and exchange information with one another have been developed. Perhaps the most outstanding example of this distributed computing is the World Wide Web (often known simply as the “web”), a collection of resources which are made available throughout the world using the Internet. People from schoolchildren to the elderly are learning to use the web, and finding an almost endless variety of information from the convenience of their homes or places of work. Businesses, government, organizations and even ordinary individuals are making information available on the web, to the degree that it is now the expectation that anything worth knowing about is available somewhere on the web.

The Internet, which provides the support for the web as well as for e-mail and other forms of communication and distributed processing among multiple digital systems, is a heterogeneous network of digital devices (nodes) connected by multiple links, so that between any two nodes of the network there are typically multiple paths, giving the Internet some degree of redundancy. Data is sent in packets, each packet being routed across multiple successive nodes until it reaches its destination. In order to support communication between any two arbitrary nodes coupled to the Internet, a global naming convention is used to assign a unique name to each node. This naming convention is known as the Domain Name System, or DNS. A source node connected to the Internet, having only the global DNS name of a target node, can send a data packet to the target. Various DNS servers and other devices translate the global DNS name to an Internet Protocol (IP) address, allowing the various routers and other devices on the Internet to correctly determine a path for the data packet to its final destination node.

At the basic level of routing packets, the Internet is capable of transferring any arbitrary data from one node to another, and may thus be viewed as a communications medium. However, the usefulness of the Internet depends on the applications which handle data exchanges at the source and destination nodes. The advent of web browsers and other web applications has thus greatly expanded the use of the Internet, by making the basic information transfer technology available for use on an individual, interactive basis to people without extensive computer programming skills.

Within a computer system attached to the Internet, a set of low-level processes receives inbound data packets from an Internet connection, assemble data within the packets, and provide the data to one or more higher-level applications; and similarly receive outbound messages, files or similar structures from the higher-level applications, construct one or more outbound data packets embodying each such structure, addresses the data packets, and transmit the data packets across the Internet connection. These processes are referred to herein as an Internet communications stack or TCP/IP stack, where TCP/IP is a well known acronym for Transmission Control Protocol/Internet Protocol.

An Internet communications stack or TCP/IP stack (or “stack instance”) is a process instantiation of computer programing code for performing low-level Internet communications functions described above. For any of various reasons, it is sometimes desirable to employ multiple Internet communications stacks within a single computer system. These multiple Internet communications stacks may, although need not necessarily, use the same or portions of the same underlying TCP/IP or other computer programming code, but each will have its own independent state data and each will have its own IP address (or set of IP addresses).

One example of the use of such multiple Internet communications stacks is a computer system which has one (or more) stacks for performing useful applications on behalf of users, herein referred to as production stacks, and a separate one (or more) stacks for tasks which remotely administer, maintain and control the computer system itself, herein referred to as service stacks. It may be desirable to isolate user applications from system administrative functions for various reasons. For example, even if the production stack is overloaded or inoperative, system maintenance and control operations can be performed through the service stack; concurrent maintenance can be performed through the service stack without interfering with ongoing operations in the production stack; etc.

An Internet communications stack necessarily performs certain core functions required for network communications in accordance with the governing protocol, but may also perform any of various advanced or optional functions as required. Where a computer system contains multiple Internet communications stacks, as in the case of a production and a separate service stack, there is at least some duplication of core function among the multiple stacks. However, advanced or optional functions are not necessarily duplicated since duplication requires additional resource, and these functions may not be available in all stacks. If there is a need to access an advanced function for processing a communication in a stack which does not support that function, it is possible to invoke functions in another stack by routing data over a local area network (LAN) connection to the other stack. Unfortunately, this solution is less than ideal. It consumes network resource on the LAN, and each stack may require its own dedicated network adapter to perform such an operation.

It is further possible to route data between different Internet communications stacks internally by defining ports associated with different stacks and using designated ports as destinations of data. Port forwarding allows a single adapter to be shared by both stacks. However, since some data packets don't include port designations (or the ports are not accessible, port forwarding is not always available. For example, in certain packets in which the data is encrypted for use in a virtual private network, the port is also encrypted and can not be used for inter-stack routing using conventional port forwarding.

It would be desirable to provide improved techniques for communicating data between Internet communications stacks in a computer system which avoid certain disadvantages of the existing art. In particular, it would be desirable to provide inter-stack communications facilities which do not impose additional traffic on the LAN, which support sharing of a single hardware LAN adapter, and which are easily integrated into the existing software supporting the Internet communications protocols.

### SUMMARY OF THE INVENTION

A computer system contains multiple Internet communications stack instances, which may share a common hardware network adapter or be associated with separate respective hardware network adapters. A system internal software communications path is defined for the multiple stack instances, whereby packets are routed between different Internet communications stack instances within the computer system using Internet Protocol (IP) addressing. A packet arriving in one stack and having a destination IP address associated with another stack is forwarded to the other stack using IP forwarding.

In the preferred embodiment, inter-stack routing of packets may use either globally defined Internet IP addresses or local intranet (encapsulated) IP addresses, and may apply to either inbound or outbound packets. For example, it is possible for an inbound packet to arrive in a first stack, be forwarded to a second stack using a global IP address, and be re-forwarded back to the first stack using a local intranet IP address. It is further possible for an outbound packet to arrive in a first stack, be forwarded to a second stack using a local intranet IP address, and to be re-forwarded back to the first stack using a global IP address. Numerous other usages are possible.

In an exemplary environment of the preferred embodiment, a first stack is a production stack having a full range of TCP/IP functions to support a variety of user applications in a general-purpose computer system, and a second stack is a service stack having a limited range of TCP/IP functions, and which exists primary to support system control from a remote console, concurrent maintenance operations and the like. The inter-stack interface can be used to obtain advanced function operations for packets arriving for and being sent by applications bound to the service stack.

In one variation of the preferred embodiment, the inter-stack interface can also be used to support sharing of a common hardware network adapter by multiple stacks. The inter-stack interface can operate as a switch to selectively enable or disable sharing. In another variation, the inter-stack interface can be used to temporarily re-route data to a backup stack instance while routine maintenance is performed on the production stack.

The present invention thus provides a simple internal inter-stack interface using IP addressing, which enables inter-stack communication without using the facilities of a network, and without the development cost of special software to handle inter-stack communications or provide desired level of function in all stack instances.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level representation of the Internet.

FIG. 2 is a high-level block diagram of the major hardware components of a host computer system, according to the preferred embodiment.

FIG. 3 is a conceptual illustration of the major software components of a host computer system, according to the preferred embodiment.

FIG. 4 is a generalized flow diagram illustrating at a high level the process of processing an inbound data packet within an Internet communications stack instance, according to the preferred embodiment.

FIG. 5 is a generalized flow diagram illustrating at a high level the process of processing an outbound data packet within an Internet communications stack instance, according to the preferred embodiment.

FIG. 6 is a flow diagram showing the processing of an inbound data packet, according to an exemplary environment in which an encapsulated data packet bound for a service application is routed to the production stack for IPSec processing, according to the preferred embodiment.

FIG. 7 is a flow diagram showing the processing of an outbound data packet, according to the exemplary environment of FIG. 6.

### DETAILED DESCRIPTION OF THE PREFERRED EMBODIMENTS

Internet Overview

Prior to discussing the operation of embodiments of the invention, a brief overview discussion of the Internet is provided herein.

The term “Internet” is a shortened version of “Internetwork”, and refers commonly to a collection of computer networks that utilize the TCP/IP and related suite of protocols, well-known in the art of computer networking. TCP/IP is an acronym for “Transport Control Protocol/Internet Protocol”, a software protocol that facilitates communications between computers.

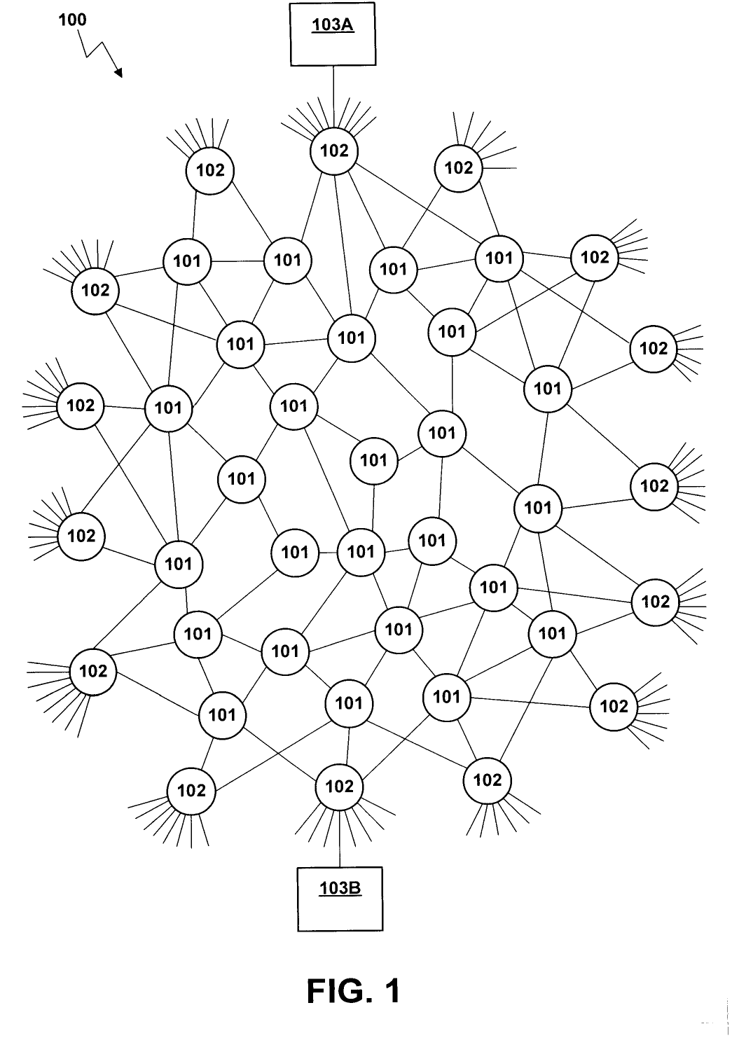

FIG. 1 is a high-level conceptual view of the Internet. The Internet has no pre-established topology, and is indefinitely extensible by adding new nodes and links. A node may have any number of links connecting it to other nodes, and these may use any of various communications technologies, having different data capacities and other characteristics. The topology of the Internet therefore becomes an extremely complex interconnected network, in which there are typically a large number of possible pathways between any two nodes.

The central part of the network, sometimes called the “backbone”, contains multiple high-speed routers 101 which receive data packets and forward these on to other nodes in the network. Typically, each router has multiple connections to other routers, and these connections have a high data capacity. For example, fiber optic links are often used between high-speed routers 101. Connected to the high-speed routers are nodes which serve as access points to the Internet “backbone” of high-speed routers, illustrated in FIG. 1 as nodes 102. Access nodes 102 are also routers since they function to route data packets between the high-speed routers 101 and other network nodes, but they typically employ lower-speed connections. An access node may be, for example, a public Internet Service Provider which provides access to the Internet through telephone lines or other connections for a fee, or may be an access node of a large company for its internal systems. Usually, each access node 102 connects to multiple high-speed routers 101 to provide redundancy, although this is not a requirement. Each access node typically provides access to multiple host computer systems 103A, 103B (referred to generically as reference numeral 103), of which only two are illustrated in FIG. 1. Hosts 103 are the computer systems which connect to the Internet and which generate as the source or receive as the ultimate destination the data packets transmitted over the Internet. Hosts 103 may be any type of computer system, from large mainframe systems to PCs to handheld portable devices, and a single host may represent a cluster of systems. Often, a host has only one access node 102 which it uses to access the Internet ( in which case it is non-redundant), although it may have multiple such access nodes for redundancy. The connection between the host and the access node is often relatively low speed (such as a telephone line or radio frequency link), but could be a high-speed link. In the case of some computer systems, such as large Internet servers which function primarily to provide information over the Internet, the host may be connected directly to high-speed routers 101 and therefore serve as its own access node.

It will be understood that FIG. 1 is intended as a conceptual illustration of the Internet, and that in reality the number of nodes and connections on the Internet is vastly larger than illustrated in FIG. 1, and that the topology of the connections may vary. Furthermore, it will be understood that there may be further hierarchies of types of connections and forms of access, which are not shown in FIG. 1 for clarity of illustration. I.e., there may be multiple types or classes of access node 102 through which a host connects to reach the high-speed routers 101 of the backbone, and that different hosts may connect at different levels of access node. Strictly speaking, the Internet comprises all devices coupled to it, and when a small computer system such as a PC is logged on to the Internet, it is part of the Internet in the sense that it becomes an Internet node and has an Internet Protocol (IP) address (although the IP address may be only temporary). Often, the routers and connections of the Internet backbone and access nodes are referred to as the Internet, i.e., the Internet is viewed as a communications medium as opposed to a distributed processing network of computer systems. In general, the “Internet” is used herein in the latter sense to describe the communications medium, although, depending on the context, the former sense may be employed.

In order to enable communication of data in any network from one arbitrary node to another, the sending node must specify the destination of the receiving node. For very small networks, such as a local area Ethernet network, it is possible to broadcast data to all nodes in the network, identifying the desired recipient with a simple addressing scheme. The size of the Internet makes such an approach impractical. It is still necessary for the sender to specify a destination, but it is not practical to transmit the data to every node in the network until the destination is found. This means that the sender, and every node in between the sender and recipient in the pathway, must be able to make a determination where to route the data packet so that it reaches its destination. Although every node in the pathway must be able to make a determination where to route the packet on the next intermediate link, it is not necessary that every node in the pathway know the ultimate destination. Generally, there will be multiple possible routes and a router may decide which to use based on various factors.

At the level of the router hardware, an Internet destination node is specified by a multi-bit numerical address, called an Internet Protocol (IP) address. The original Internet addressing system used a 32-bit IP address divided into four parts or “octets” of 8 bits each. These octets are often written separated by periods, e.g., an IP address might be written as: 90.4.63.18. The octets are a hierarchical form of addressing, and it is not necessary for any single router to know the ultimate destination of all Internet addresses. A data packet bearing a distant address will be routed to a router which is closer and therefore able to further refine the address, and so on until the data packet reaches its ultimate destination. Although the original addressing system used a 32-bit IP address, in recent years the Internet address space has become constrained, and a new standard, known as IPv6 , has been adopted for Internet IP addresses. IPv6 supports IP addresses of 128 bits. IPv6 is currently being phased in, and many Internet devices still use the older 32-bit IP addressing protocol, known as IPv4.

An IP address allows a sending node to route a data packet to a receiving node, but there would be drawbacks to using a numerical IP address for higher-level interprocess communications using the Internet. For one thing, numerical addresses are hard for people to remember. Additionally, some IP addresses might be shared among multiple nodes, or might change due to changes in network configuration. For these and other reasons, a higher level naming convention for Internet nodes exists, which is called the Domain Name System (DNS). Internet nodes are given names in the DNS having arbitrary alphabetic characters, which are then translated to IP addresses. The DNS name of a node can thus be made easier to remember, and need not change simply because some hardware has changed. For example, a person can establish a web server having a familiar DNS name which clients are likely to remember, and can maintain the same DNS name even if the actual IP address of the web server changes due to hardware upgrades and so forth. A distributed system of DNS servers records DNS names and their corresponding IP addresses and provides a mechanism for translating DNS names to IP addresses.

Since a router functions to choose one of multiple communication links (immediate destinations) for a given data packet based on the IP address of the packet, multiple IP addresses may be associated with each link. There is nothing in the architecture which prohibits a single host node from having multiple IP addresses, since the router or routers to which it is connected will simply associate all of the IP addresses with the single destination node. Typically, an individual workstation or personal computer, acting as a client and executing an application such as an interactive web browser, will have only a single IP address. However, some larger computer systems may have multiple IP addresses, each associated with different respective sets of internal processes.

Within a host node computer system coupled to the Internet, a set of hierarchical processes receives outbound data from an application and formats it appropriately in data packets, having appropriate IP address designations, for transmission on the Internet. Similarly, the set of hierarchical processes received data packets from the Internet, extracts and assembles the data, and provides it to the application. This set of hierarchical processes is sometimes referred to herein as an “Internet communications stack”. It is sometimes referred to in the industry as a “TCP/IP stack”, although Internet communications handled by the stack need not be limited to the TCP/IP protocol, and could include other protocols such as UDP/IP, ICMP/IP, and so forth. A single host computer system may contain multiple instances of an Internet communications stack, each used for its own purpose. Where multiple Internet communications stack instances are active in a single host computer system, each stack typically has its own distinct IP address (or set of IP addresses).

### DETAILED DESCRIPTION

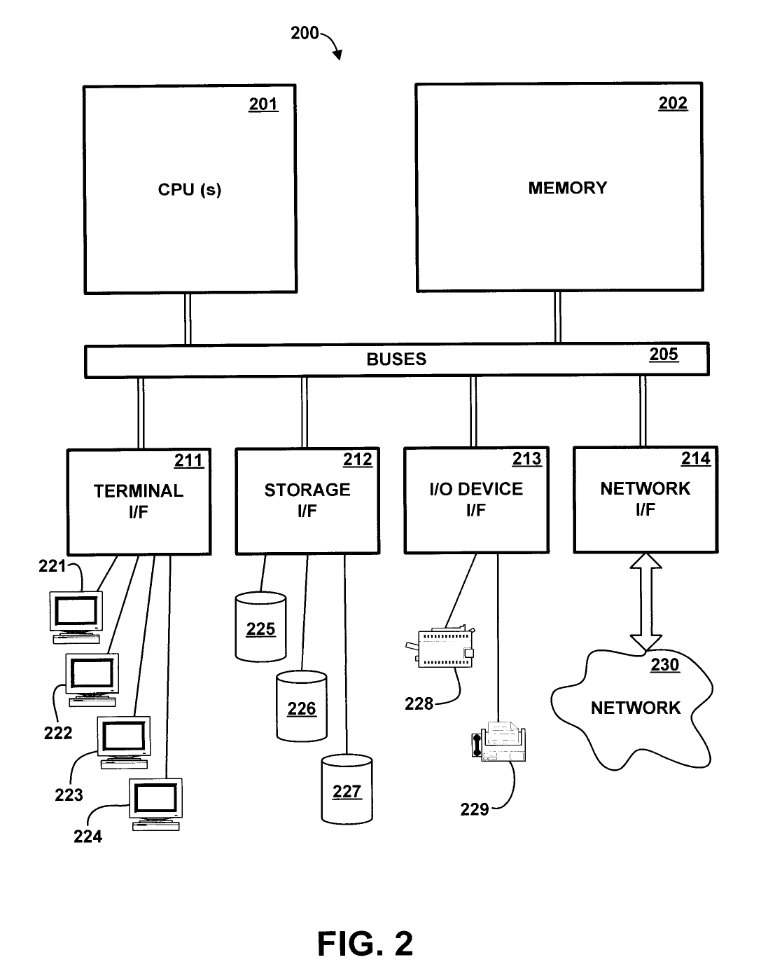

Referring to the Drawing, wherein like numbers denote like parts throughout the several views, FIG. 2 is a high-level block diagram of the major hardware components of a host computer system 200 which communicates with other systems over the Internet, according to the preferred embodiment. CPU 201 is at least one general-purpose programmable processor which executes instructions and processes data from main memory 202. Main memory 202 is preferably a random access memory using any of various memory technologies, in which data is loaded from storage or otherwise for processing by CPU 201.

One or more communications buses 205 provide a data communication path for transferring data among CPU 201, main memory 202 and various I/O interface units 211-214, which may also be known as I/O processors (IOPs) or I/O adapters (IOAs). The I/O interface units support communication with a variety of storage and I/O devices. For example, terminal interface unit 211 supports the attachment of one or more user terminals 221-224. Storage interface unit 212 supports the attachment of one or more direct access storage devices (DASD) 225-227 (which are typically rotating magnetic disk drive storage devices, although they could alternatively be other devices, including arrays of disk drives configured to appear as a single large storage device to a host). I/O device interface unit 213 supports the attachment of any of various other types of I/O devices, such as printer 228 and fax machine 229, it being understood that other or additional types of I/O devices could be used.

Network interface (or “network adapter”) 214 supports a connection to one or more external networks 230 for communication with one or more other digital devices. Network 230 includes the Internet, although network interface 214 is not necessarily directly coupled to the Internet; it may be connected to a local area network (not shown), which in turn communicates with the Internet through a gateway. The host computer system 200 of the preferred embodiment contains at least one network adapter 214. It may optionally contain multiple network adapters. Where system 200 contains multiple adapters, one or more than one may be coupled, directly or indirectly, to the Internet, and these adapters may connect to the same or different local area networks, or the same or different routers or gateways.

It should be understood that FIG. 2 is intended to depict the representative major components of system 200 at a high level, that individual components may have greater complexity than represented in FIG. 2, that components other than or in addition to those shown in FIG. 2 may be present, and that the number, type and configuration of such components may vary, and that a large computer system will typically have more components than represented in FIG. 2. Several particular examples of such additional complexity or additional variations are disclosed herein, it being understood that these are by way of example only and are not necessarily the only such variations.

Although only a single CPU 201 is shown for illustrative purposes in FIG. 2, computer system 200 may contain multiple CPUs, as is known in the art. Although main memory 202 is shown in FIG. 2 as a single monolithic entity, memory 202 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 205 are shown in FIG. 2 as a single entity, in fact communications among various system components is typically accomplished through a complex hierarchy of buses, interfaces, and so forth, in which higher-speed paths are used for communications between CPU 201 and memory 202, and lower speed paths are used for communications with I/O interface units 211-214. Buses 205 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate system buses 205 from various communications paths running to the various I/O devices, it would alternatively be possible to connect some or all of the I/O devices directly to one or more system buses.

Computer system 200 depicted in FIG. 2 has multiple attached terminals 221-224, such as might be typical of a multi-user “mainframe” computer system. The actual number of attached devices may vary, and the present invention is not limited to systems of any particular size. Computer system 200 might alternatively be a single-user system such as “personal computer”. User workstations or terminals which access computer system 200 might also be attached to and communicate with system 200 over network 230. Computer system 200 may alternatively be a system containing no attached terminals or only a single operator's console containing only a single user display and keyboard input. Furthermore, while certain functions of the invention herein are described for illustrative purposes as embodied in a single computer system, these functions could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 200 is a computer system based on the IBM i/Series™ architecture, it being understood that the present invention could be implemented on other computer systems.

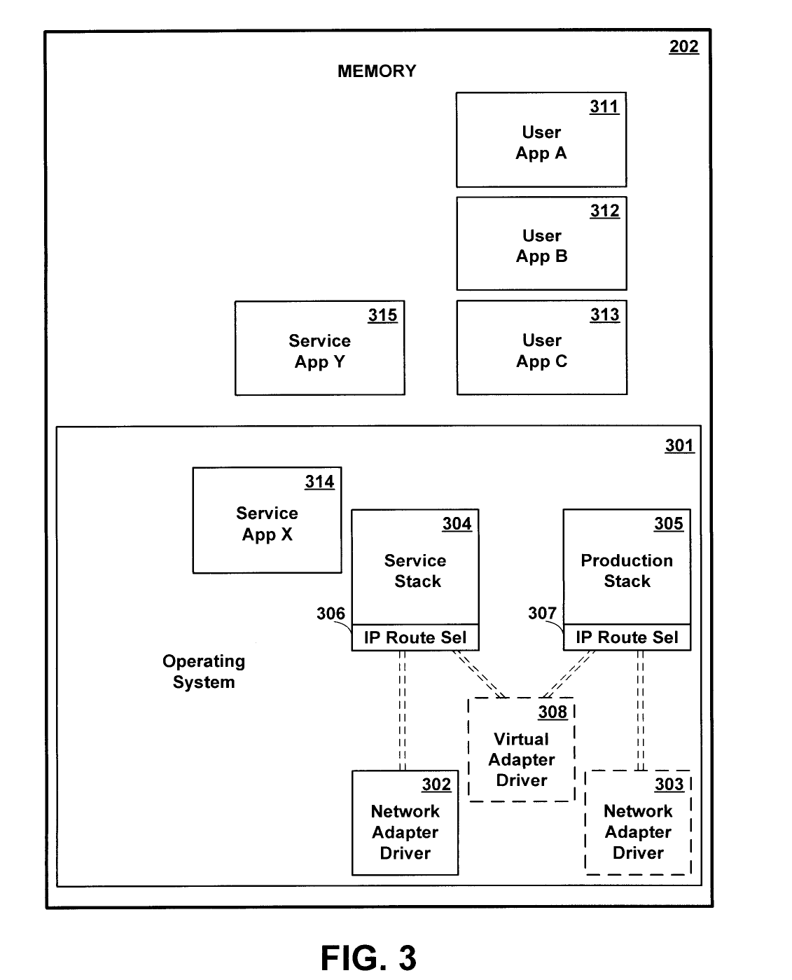

FIG. 3 is a conceptual illustration of the major software components of host computer system 200, represented as components of memory 202, according to the preferred embodiment. Operating system 301 is executable code and state data providing various low-level software functions, such as device interfaces, management of memory pages, management and dispatching of multiple tasks, etc. as is well-known in the art. In particular, operating system 301 includes a respective network adapter device driver for each network adapter 214 of system 200. FIG. 3 represents a first network adapter device driver 302 and an optional second network adapter device driver 303, optional network adapter device driver 303 appearing in dashed lines to indicate that this feature represents an optional embodiment. Where system 200 contains only a single network adapter 214, only a single corresponding network adapter device drive 302 will be present; where system 200 contains a second network adapter (not shown in FIG. 2), a corresponding additional network adapter device drive 303 will be present.

A host computer system according to the preferred embodiment contains multiple Internet communications stack instances. In the particular exemplary embodiment represented in FIG. 3, it contains two Internet communications stack instances, one of these being a service stack 304 and the other being a production stack 305. However, host system 200 could contain more than two Internet communications stack instances. Both stacks implement a core set of TCP/IP and/or other Internet protocol functions necessary for communication over the Internet, including in particular IP routing. However, in addition to these core protocols, production stack 305 supports a substantially full range of TCP/IP and/or other Internet protocol advanced functions, while the service stack supports fewer (or none) of these advanced functions. These advanced functions are functions which are needed only by certain applications or environments. Examples of such advanced functions include IPSec, IP Filtering, Network Address Translation (NAT), and Intrusion Detection, it being understood that the production stack may support other or additional advanced functions.

In general, production stack 305 is used to support a variety of user applications for the productive work performed on computer system 200. Support for a broad range of advanced TCP/IP or other Internet protocol functions is desirable because some user applications may need a particular advanced function, and it is difficult to predict in advance the characteristics of user applications and which functions will be needed by the user applications executing on system 200. The service stack exists primarily for maintenance and control purposes. For example, the service stack may be used to support network communications with a remote console for controlling the operation of system 200; for performing concurrent maintenance operations on system 200, and for similar administrative functions.

System 200 further contains one or more user applications 311-313 (of which three are represented in FIG. 3, it being understood that the actual number may vary, and is typically much larger). User applications 311-313 communicate with remote processes over the Internet to perform productive work on behalf of users, and are preferably associated with production stack 305 to handle Internet communications in accordance with TCP/IP or some other applicable Internet protocol. System 200 also contains one or more service applications 314-315 (of which two are represented in FIG. 3, it being understood that the actual number may vary, and is typically much larger). Service applications communicate with remote processes to perform administrative functions, and are preferably associated with service stack 304 to handle Internet communications in accordance with TCP/IP or some other applicable Internet protocol. In the example of FIG. 3, service application 314 is represented as part of operating system 301 while service application 315 is represented as separate from operating system 301, in order to illustrate that a service application may or may not be part of the operating system. Applications associated with the production stack, such as user applications 311-313, typically are not part of the operating system, although the production stack could provide service to operating system functions as well.

Each network adapter device driver 302, 303 is bound to a respective Internet communications stack. Each Internet communications stack 304, 305 may have, zero, one, or more than one, network adapter device drivers bound to it. All incoming packets received in a network adapter are routed initially into the Internet communications stack to which the corresponding network adapter device driver is bound. A respective IP route selector 306, 307 in each stack determines a destination network adapter device driver for each outgoing packet, using an IP routing protocol.

In accordance with the preferred embodiment of the present invention, a system-internal inter-stack communications path is established through the IP route selector to another stack. Each IP route selector 306, 307 is configured to route certain packets to a virtual network adapter device driver 308. The virtual network adapter device driver 308 is not a device driver at all, in the sense that it does not actually drive a physical network adapter. Rather, is simply functions as a destination under the IP routing protocol to which the IP router can route packets, thus establishing an internal inter-stack communications path. A packet routed to the virtual network adapter device driver 308 in fact is routed to the other stack. I.e., if route selector 306 in service stack 304 selects the virtual network adapter device driver 308 as the destination of a packet using IP routing, the packet is then routed to the production stack 305, and entered in the production stack for processing in the same manner as would a packet coming from an actual network adapter and corresponding network adapter device driver 303 bound to the production stack.

It will be understood that a typical computer system will contain many other software components (not shown), which are not essential to an understanding of the present invention. In particular, a typical operating system will contain numerous functions and state data unrelated to the transmission of data across a network.

Various software entities are represented in FIG. 3 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representations of FIG. 3, it will be understood that the actual number of such entities may vary, and in particular, that in a complex host system environment, the number and complexity of such entities is typically much larger.

While the software components of FIG. 3 are shown conceptually as residing in memory 202, it will be understood that in general the memory of a computer system will be too small to hold all programs and data simultaneously, and that information is typically stored in data storage devices 225-227, comprising one or more mass storage devices such as rotating magnetic disk drives, and that the information is paged into memory by the operating system as required. Furthermore, it will be understood that the conceptual representation of FIG. 3 is not meant to imply any particular memory organizational model, and that system 200 might employ a single address space virtual memory, or might employ multiple virtual address spaces which overlap.

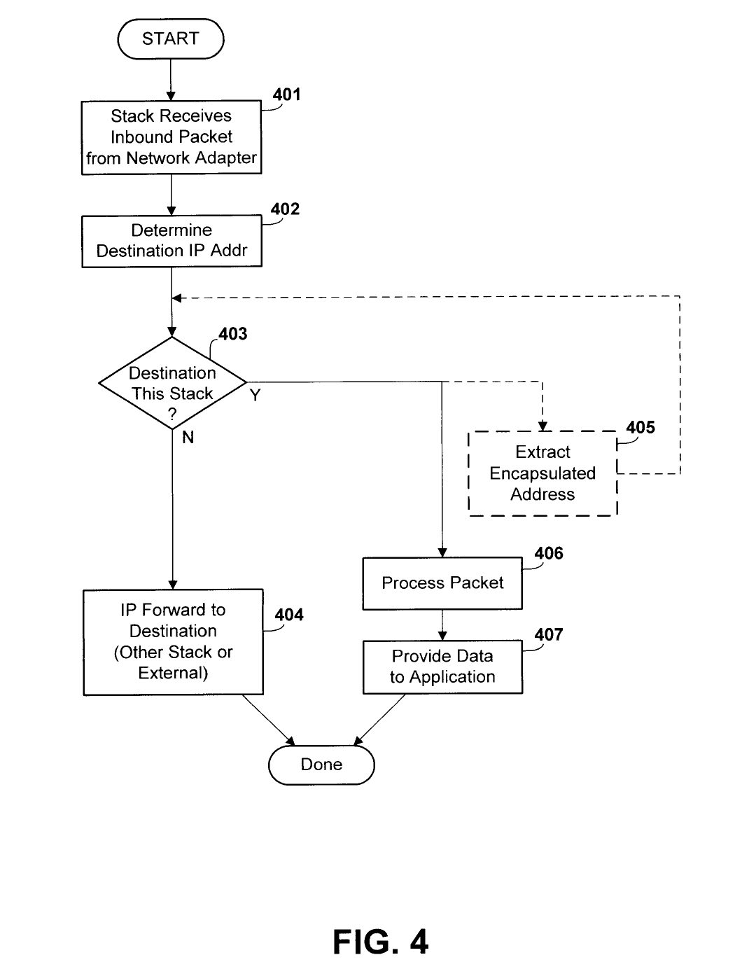

FIG. 4 is a generalized flow diagram illustrating at a high level the process of processing an inbound data packet (i.e, inbound from the Internet) within an Internet communications stack instance 304, 305, according to the preferred embodiment. Referring to FIG. 4, the stack instance receives the inbound data packet from a network adapter driver (step 401). The source of the data packet received in step 401 could be a network adapter driver 302, 303 for a physical hardware network adapter, or could be a virtual network adapter driver 308, which is in reality merely an interface to another stack instance which communicates with the receiving stack instance as a network adapter. Upon receiving the packet, IP route selector 306, 307 examines the destination IP address in the packet to determine an appropriate routing (step 402). If the destination address is associated with another entity (the ‘N’ branch from step 403), the packet is then forwarded (using IP forwarding) to the destination entity (step 404). A packet could be destined for some location external to computer system 200, in which case the packet may be forwarded to a network adapter associated with the external location, for external transmission toward its ultimate destination. But in particular, in the preferred embodiment it is possible to forward at least some packets to a different Internet communication stack instance within system 200 by IP forwarding to a virtual adapter driver 308 associated with the destination stack.

If, at step 403, the destination address is associated with the current stack instance, the packet is forwarded up the stack for processing by the various stack levels (represented as the ‘Y’ branch from step 403). Optionally, processing may include revealing an encapsulated IP address, different from the original IP address, embedded within the original data packet (step 405). An encapsulated IP address may be revealed by any applicable protocol for IP address encapsulation. For example, in accordance with the IPSec tunneling protocol, an encapsulated IP address may be extracted from a decrypted data packet, IPSec tunneling being just one possible example of encapsulation. Where an encapsulated IP address is revealed, the packet is then returned to the IP route selector (step 403) for IP forwarding to the appropriate destination entity (step 404). This destination entity could be a different Internet communications stack instance within system 200.

Where there is no encapsulated IP address (or such an encapsulated address has been previously extracted and the packet forwarded accordingly), the upper levels of the stack (e.g., IP and TCP levels) process the packet according to the applicable conventional protocols (step 406). The data in the packet is then provided to the appropriate application within system 200 (step 407).

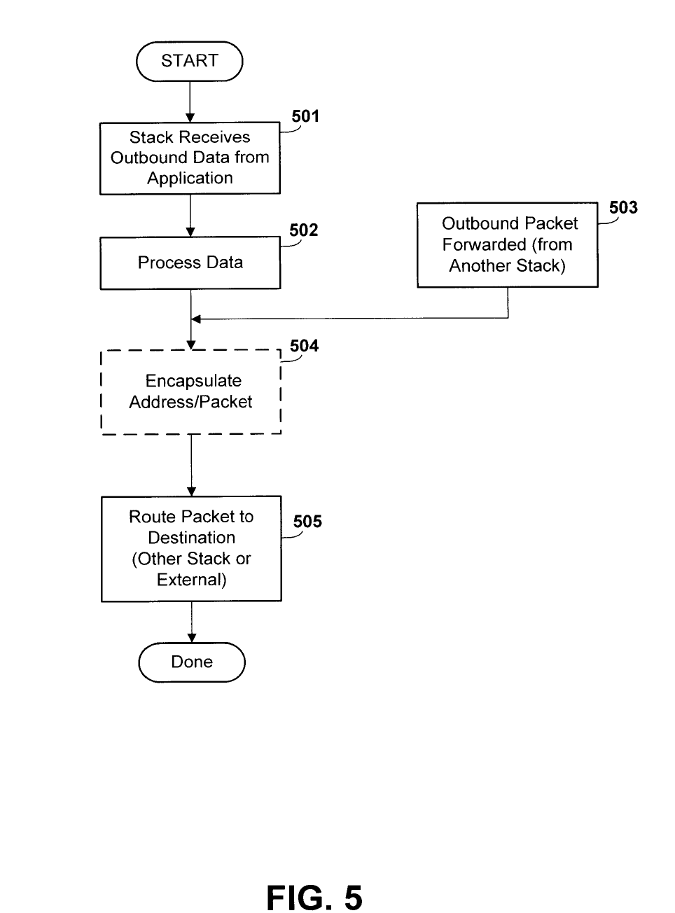

FIG. 5 is a generalized flow diagram illustrating at a high level the process of processing an outbound data packet (i.e, outbound to an external destination, over the Internet) within an Internet communications stack instance 304, 305, according to the preferred embodiment. Referring to FIG. 5, the outbound data packet may be a result of data from an application bound to the stack instance (shown as the path through steps 501 and 502), or it may be a data packet which is forwarded from another entity, particularly from another stack (shown as the path through step 503). In the former case, the stack instance receives data intended for an outbound Internet communication from an application bound to the stack (step 501), such as user applications 311-313 in the case of production stack 305, or service applications 314, 315 in the case of service stack 304. The upper levels of the stack (e.g., IP and TCP levels) process the data according to the applicable protocols to produce one or more data packets (step 502). Alternatively, the data packet, already processed by the higher stack levels, may arrive in the stack after being routed from another entity, particularly from another stack in the same system (step 503).

The stack may optionally encapsulate the data packet and destination address within a larger data packet, providing a new IP address for the larger data packet, in accordance with any appropriate encapsulation protocol, such as IPSec tunneling (step 504). Whether or not encapsulation step 504 is performed, the packet is then forwarded to the destination indicated by its IP address by IP route selector 306, 307 (step 505). The IP forwarding route destination is a network adapter driver. This destination could be a network adapter driver 302, 303 coupled to a physical network adapter (in the case of external destinations) or could be a virtual adapter driver 308 which is an interface to another stack instance in system 200.

Inter-stack communication in accordance with the preferred embodiment as described above can be used in a variety of applications. For example, inter-stack communication readily supports sharing of a single hardware network adapter by multiple stack instances. Typically, the hardware network adapter will be owned by or activated by a first stack instance, requiring all communications to be routed through the IP route selector associated with the first stack instance. But the IP route selector may route incoming packets to a second stack instance, or receive outgoing packets from a second stack instance, thus supporting communication between the second stack instance and external entities through the network adapter (which is not owned by the second stack instance). The inter-stack interface can also operate as a switch which is selectively enabled at certain times or events. For example, the interface can be enabled normally and disabled at certain times to support mission critical applications which require dedicated use of the network adapter. Alternatively, the interface could be normally disabled, to at selective times enabled to re-route data from a primary stack instance to a backup stack instance in order to perform routine maintenance on the primary stack.

In the particular exemplary environment for using an inter-stack interface according to the preferred embodiment, production stack 305 has a full range of TCP/IP functions to support a variety of user applications in a general-purpose computer system, and service stack 304 has a limited range of TCP/IP functions, which exist primarily to support system control from a remote console, concurrent maintenance operations and the like. The inter-stack interface is used to obtain one or more advanced function operations, not normally available on the service stack, for communications involving applications bound to the service stack.

An example of one such advanced function is encapsulation of data packets using the IPSec tunneling protocol. IPSec tunneling allows a complete data packet to be encapsulated and encrypted, and to be wrapped into a larger packet having a new IP header and IP address. IPSec tunneling can be used, e.g., to support a virtual private network (VPN). In a system having dual production and service stack instances, there may sometimes be a need for the service stack to use the IPSec capabilities of the production stack. For example, some maintenance operation may from time to time need to be performed from a device attached over an unsecure network.

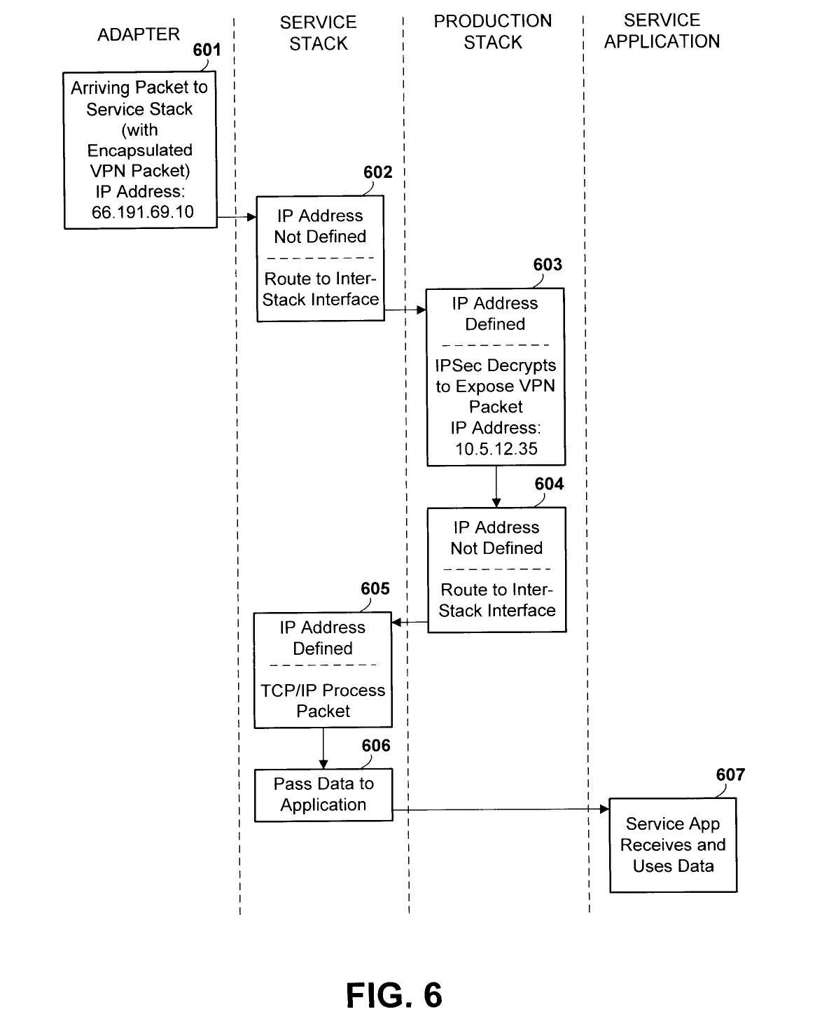

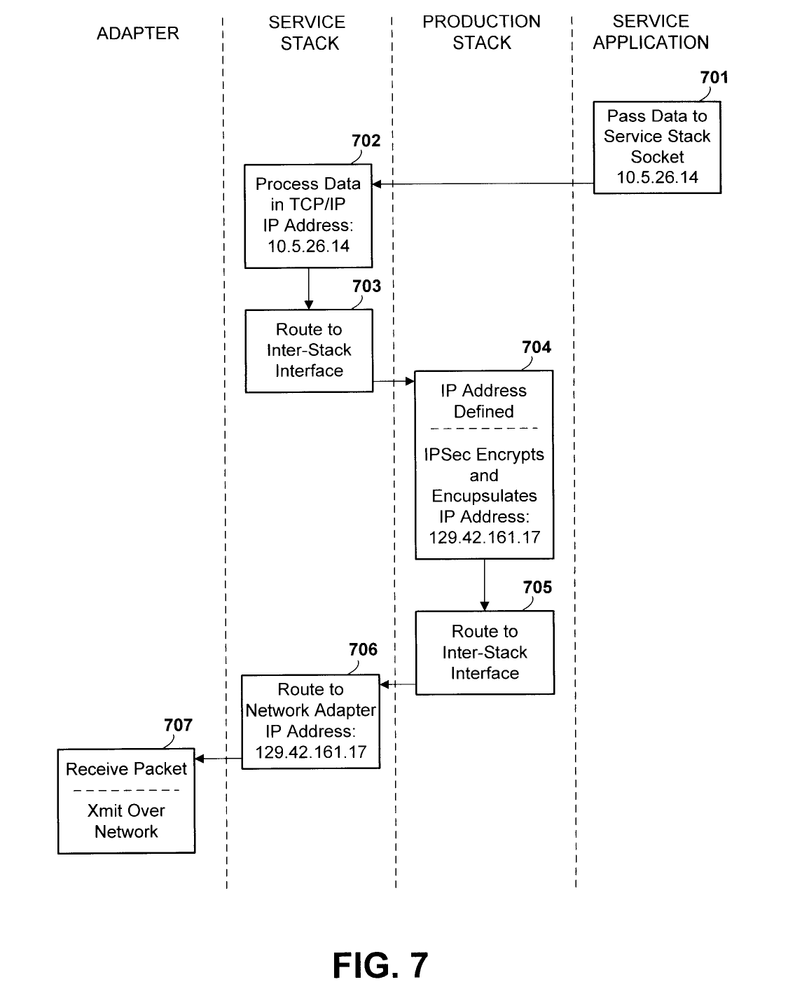

FIG. 6 and FIG. 7 are flow diagrams showing respectively the processing of an inbound data packet and the processing of an outbound data packet in various components of system 200, according to an exemplary environment in which an encapsulated data packet bound for a service application is routed to the production stack for IPSec processing, according to the preferred embodiment. In this example, Internet IP addresses 66.191.69.9 and 66.191.69.10 are routed to network adapter 302 bound to service stack 304. Internet IP address destination 66.191.69.9 is defined on the service stack and Internet IP address 66.191.69.10 is defined on the production stack. There could be additional Internet IP addresses defined for these stacks and/or additional network adapters, not pertinent to this example. An intranet virtual private network (VPN) address destination 10.5.12.35 is defined on the service stack and a VPN filter rule for remote intranet address destination 10.5.26.14 is defined on the production stack.

Referring to FIG. 6, an inbound packet having an IP address of 66.191.69.10 and an encapsulated packet (VPN packet) arrives in network adapter 302, and is routed to service stack 304 to which network adapter 302 is bound (step 601). IP address 66.191.69.10 is not defined on the service stack; however, it is defined as a route to virtual adapter 308, i.e. a route to production stack 305. Therefore IP route selector 306 routes the packet to production stack 305 using IP forwarding (step 602).

Production stack receives the packet. IP address 66.191.69.10 is defined on the production stack, so the production stack's IPSec tunneling function decrypts the packet to expose the embedded VPN packet (step 603). This embedded VPN packet has its own IP address of 10.5.12.35, which in this case is an intranet address for use on the virtual private network. The intranet IP address 10.5.12.35 is not defined on the production stack; however, it is defined as a route to virtual adapter 308, i.e., to the service stack. Therefore IP route selector 307 routes the now decrypted packet back to the service stack (step 604).

Service stack receives the decrypted packet having IP address 10.5.12.35. This address is defined on the service stack, so the packet is processed at the higher levels of the service stack, i.e. the TCP and IP levels (step 605). The resultant data is then passed to the service application (step 606). The service application receives the data from the service stack and uses the data appropriately (step 607).

Referring to FIG. 7, outbound data from the service application is passed initially to the service stack with a socket destination address of 10.5.26.14, corresponding to an intranet IP address of a destination in a remote device (step 701). This data is processed in the TCP and IP layers of service stack, producing one or more data packets having the IP address destination 10.5.26.14 (step 702).

IP address 10.5.26.14 is defined to IP route selector 306 as an address corresponding to virtual adapter 308, so route selector 306 routes the packet to virtual adapter 308, i.e. to production stack 305 via the inter-stack interface (step 703). A VPN filter rule for IP address 10.5.26.14 is defined in production stack 305, instructing the production stack's IPSec function to then encrypt the packet and encapsulate it in a larger packet, having a globally routable (Internet) IP address of 129.42.161.17, corresponding to a remote device (step 704). The address 129.42.161.17 is defined to IP route selector 307 as an address corresponding to virtual adapter 308, so route selector 307 routes the packet via the inter-stack interface to service stack 304 (step 705).

IP Route selector 306 in service stack 304 receives the packet and recognizes the IP address as an external address routable to network adapter driver 302. IP route selector 306 accordingly routes the packet to adapter driver 302 (step 706). The network adapter then receives the packet and transmits it over the network (step 707).

Although certain examples are used herein of an IPv4 embodiment, it will be understood that the present invention is equally applicable to IPv6 addressing as well as IPv4 addressing.

Among the advantages of the technique described herein as a preferred embodiment is that packet data can be routed between different Internet communication stack instances using the already available IP forwarding and routing facilities. This approach requires only a minimal amount of configuration of the IP route selectors, and does not require extensive special programming or functional capability. Furthermore, since IP forwarding is ubiquitous in Internet communications, use of an inter-stack interface in accordance with the preferred embodiment of the present invention is likely to have broad applicability, with few if any exceptions for which it will not function. Finally, there is no requirement that different stack instances use a common code or code having a common development origin; independently developed stack code can be advantageously used to avoid having the same coding error plague every stack instance, thus improving fault tolerance.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 2 as system memory 202, and as data storage devices 225-227.

Although a specific embodiment of the invention has been disclosed along with certain alternatives, it will be recognized by those skilled in the art that additional variations in form and detail may be made within the scope of the following claims:

What is claimed is:

1. A computer system, comprising:
at least one processor;
a memory;
an operating system embodied as a plurality of instructions executable on said at least one processor, said operating system supporting the concurrent execution of a plurality of process instances;
a plurality of applications executable on said at least one processor;
at least one network adapter for communicating with a network, said network adapter transmitting data packets for communication across the Internet;
a first Internet communication stack instance and a second Internet communications stack instance, each said Internet communications stack instance being associated with a respective at least one of said plurality of applications, said first and second Internet communications stack instances supporting an inter-stack interface for communicating data packets in at least one direction between said first and second Internet communications stack;
wherein each data packet communicated across said inter-stack interface is selectively routed to a destination Internet communications stack across said inter-stack interface according to a respective Internet Protocol (IP) address associated with respective data packet, said IP address matching an IP address associated with the destination Internet communications stack.

2. The computer system of claim 1, wherein said second Internet communications stack instance supports at least one Internet protocol function not supported by said first Internet communications stack instance.

3. The computer system of claim 2, wherein said second Internet communications stack instance is a production stack for general-purpose support of user applications and said first Internet communications stack is a service stack for supporting administrative functions of said computer system.

4. The computer system of claim 1, wherein said inter-stack interface supports bi-directional communication of packets between said first and said second Internet communications stacks.

5. The computer system of claim 1, wherein data packet communication across said inter-stack interface is implemented by designating a virtual network adapter device driver as an IP forwarding destination of at least one IP address in said first stack instance, said virtual network adapter device driver being an interface to said second stack instance.

6. The computer system of claim 1, wherein said first and second Internet communications stacks share a common network adapter, said common network adapter being bound to said first Internet communications stack instance.

7. A method for routing Internet communication data packets, comprising the steps of:
receiving data representing a plurality of data packets in a first instance of an Internet communications stack within a computer system, each said data packet being associated with a respective Internet Protocol (IP) address;
determining a respective routing destination of each said data packet from its respective IP address, wherein, for at least some said data packets, the respective routing destination corresponds to a second instance of an Internet communications stack within said computer system, said determining step being performed in said first instance of an Internet communications stack; and
responsive to determining a routing destination of a data packet corresponding to said second instance of an Internet communications stack, forwarding the corresponding packet to said second instance of an Internet communications stack.

8. A method for routing Internet communication data packets of claim 7, wherein at least some of said data packets received in said receiving step are data packets received by said computer system as inbound communications from the Internet.

9. A method for routing Internet communication data packets of claim 7, wherein at least some of said data packets received in said receiving step are data packets received from at least one application executing internally on said computer system as outbound communications for transmission over the Internet.

10. A method for routing Internet communication data packets of claim 7, further comprising the step of:
performing a encapsulation function for at least some of said data packets in one of said first instance of an Internet communications stack and said second instance of an Internet communications stack, said encapsulation function being one of the set consisting of: (a) encapsulating a first data packet having a first IP address within a second data packet having a second IP address; and (b) extracting a previously encapsulated first data packet having a first IP address from within a second data packet having a second IP address.

11. A method for routing Internet communication data packets of claim 10,
wherein said step of performing an encapsulation function is performed by said second instance of an Internet communications stack after said step of forwarding the corresponding packet to said second instance of an Internet communications stack; and
wherein said method further comprises the steps of:
determining a respective routing destination of each data packet after performing said encapsulation function, said routing destination being determined from the respective packet's IP address, wherein, for at least some said data packets, the respective routing destination corresponds to said first instance of an Internet communications stack within said computer system, said determining step being performed in said second instance of an Internet communications stack; and
responsive to determining a routing destination of a data packet corresponding to said first instance of an Internet communications stack, forwarding the corresponding packet to said second instance of an Internet communications stack.

12. The method for routing Internet communication data packets of claim 7, wherein said first and second Internet communications stack instances share a common network adapter, said common network adapter being bound to one and only one of said first Internet communications stack instance and said second Internet communications stack instance.

13. A computer program product for routing Internet communication data packets, comprising:
a plurality of computer-executable instructions recorded on signal-bearing media, wherein said instructions, when executed by said computer system, cause said computer system to perform the steps of:
(a) maintaining a plurality of Internet communications stack instances within said computer system;
(b) providing an inter-stack interface for communicating data packets in at least one direction between at least some said Internet communications stack instances, each said data packet being associated with a respective Internet Protocol (IP) address;
(c) determining a respective routing destination of each of a plurality of data packets in a first Internet communications stack instance from the respective IP address of the data packet, wherein, for at least some said data packets, the respective routing destination corresponds to said inter-stack interface; and
(d) for each of said data packets subject to said determining step (c), if the respective routing destination of the data packet corresponds to said inter-stack interface, then routing the data packet from said first Internet communications stack instance to a second Internet communications stack instance within said computer system via said inter-stack interface.

14. The computer program product of claim 13, wherein said inter-stack interface supports bi-directional communication of packets between said first and said second Internet communications stacks.

15. The computer program product of claim 13, wherein at least some of said data packets routed to said second Internet communications stack instance via said inter-stack interface are data packets received by said computer system as inbound communications from the Internet.

16. The computer program product of claim 13, wherein at least some of said data packets routed to said second Internet communications stack instance via said inter-stack interface are data packets received from at least one application executing internally on said computer system as outbound communications for transmission over the Internet.

17. A computer program product of claim 13, wherein said instruction further cause said computer to perform the step of:
(e) performing a encapsulation function for at least some of said data packets in one of said first Internet communications stack instance and said second Internet communications stack instance, said encapsulation function being one of the set consisting of: (i) encapsulating a first data packet having a first IP address within a second data packet having a second IP address; and (ii) extracting a previously encapsulated first data packet having a first IP address from within a second data packet having a second IP address.

18. The computer program product of claim 17,
wherein said step (e) is performed by said second Internet communications stack instance after said step (d); and
wherein said instructions further cause the computer system to perform the steps of:
(f) determining a respective routing destination of each of the data packets subject to step (e) after performing step (e), wherein, for at least some said data packets, the respective routing destination corresponds to said inter-stack interface; and
(g) for each of said data packets subject to said determining step (f), if the respective routing destination of the data packet corresponds to said inter-stack interface, then routing the data packet from said second Internet communications stack instance to said first Internet communications stack instance via said inter-stack interface.
